(19) United States
(12) Patent Application Publication
(10) Pub. No.: US 2024/0175154 A1
(43) Pub. Date: May 30, 2024

(54) WATER ELECTROLYSIS DEVICE AND WATER ELECTROLYSIS SYSTEM USING WATER ELECTROLYSIS DEVICE

(71) Applicant: TOYOTA JIDOSHA KABUSHIKI KAISHA, Toyota-shi (JP)

(72) Inventor: Keisuke FUJITA, Susono-shi (JP)

(73) Assignee: TOYOTA JIDOSHA KABUSHIKI KAISHA, Toyota-shi (JP)

(21) Appl. No.: 18/471,695

(22) Filed: Sep. 21, 2023

(30) Foreign Application Priority Data
Nov. 24, 2022 (JP) 2022-187690

(51) Int. Cl. C25B 15/08; C25B 1/04; C25B 9/70

(52) U.S. Cl. CPC C25B 15/08; C25B 1/04; C25B 9/70

(57) ABSTRACT

A water electrolysis device includes: a water electrolysis stack; and a drain pipe. The water electrolysis stack includes a hydrogen electrode side manifold through which hydrogen generated by water electrolysis flows, an oxygen electrode side manifold through which oxygen generated by the water electrolysis flows, and a water supply manifold through which water to be used for the water electrolysis flows. The hydrogen electrode side manifold and the oxygen electrode side manifold pass in a lamination direction. The drain pipe includes a hydrogen electrode side drain pipe that is connected to the hydrogen electrode side manifold, an oxygen electrode side drain pipe that is connected to the oxygen electrode side manifold, and a connection pipe that connects the hydrogen electrode side drain pipe and the oxygen electrode side drain pipe. The connection pipe includes a drain valve that adjusts the flow rate of water that flows through the connection pipe.

### CROSS-REFERENCE TO RELATED APPLICATION

This application claims priority to Japanese Patent Application No. 2022-187690 filed on Nov. 24, 2022, incorporated herein by reference in its entirety.

### BACKGROUND

### 1. Technical Field

The present patent application relates to a water electrolysis device and a water electrolysis system using the water electrolysis device.

### 2. Description of Related Art

A water electrolysis cell includes a membrane electrode assembly and a pair of separators that are disposed on both surfaces of the membrane electrode assembly. The membrane electrode assembly includes a solid electrolyte layer, an oxygen electrode catalyst layer that is disposed on one surface of the solid electrolyte layer, and a hydrogen electrode catalyst layer that is disposed on the other surface of the solid electrolyte layer. Typically, a water electrolysis device includes a water electrolysis stack in which a plurality of the water electrolysis cells is laminated.

The water electrolysis stack includes a water supply manifold through which water to be used for water electrolysis is supplied, a hydrogen electrode side manifold through which hydrogen generated by the water electrolysis flows, and an oxygen electrode side manifold through which oxygen generated by the water electrolysis flows. A water electrolysis reaction is executed as described below. First, the water is supplied to the water supply manifold, and the water is supplied to the oxygen electrode catalysis layer of each cell. Then, voltage is applied to both ends of the water electrolysis stack, and the water electrolysis reaction is developed. Thereby, the water is decomposed in the oxygen electrode catalyst layer, so that oxygen and protons are generated. The oxygen is taken out through the oxygen electrode side manifold. The protons pass through the solid electrolyte layer, and are coupled with electrons in the hydrogen electrode catalysis layer, so that hydrogen is generated. The hydrogen is taken out through the hydrogen electrode side manifold.

Water electrolysis devices including such a water electrolysis stack are described in Japanese Unexamined Patent Application Publication No. 2001-164391 (JP 2001-164391 A) and Japanese Unexamined Patent Application Publication 2010-189689 (JP 2010-189689 A), for example. JP 2001-164391 A discloses a water electrolysis device that includes an oxygen path, a hydrogen path, and two pure water paths. Further, the literature discloses that an opening portion is provided only on an upper side on each path.

JP 2010-189689 A discloses a water electrolysis device that includes a discharge communication hole, a hydrogen communication hole, and a water supply communication hole. Oxygen and water are discharged through the discharge communication hole, hydrogen generated by the reaction flows through the hydrogen communication hole, and water is supplied through the water supply communication hole. The hydrogen communication hole is provided on a projecting portion that projects to exterior of the water electrolysis stack. Therefore, the moisture contained in hydrogen is exposed to the external atmosphere, is cooled, and thereby is condensed. The condensed moisture is stored in a water storing portion that is provided at a lower portion of the hydrogen communication hole. On the other hand, hydrogen is taken out from an opening that is provided at an upper portion of the hydrogen communication hole. In this way, the hydrogen communication hole described in JP 2010-189689 A has a gas-liquid separation function.

### SUMMARY

In the water electrolysis device in JP 2001-164391 A, on each path (manifold), the opening portion is provided only on the upper side. Therefore, the unreacted water is retained in the water electrolysis stack, and is easily taken in the upward direction. As a result, some water flows out to the downstream side of the water electrolysis device. Consequently, it is necessary to install a large gas-liquid separator.

JP 2010-189689 A describes that since the hydrogen communication hole of the water electrolysis device has the gas-liquid separation function, it is not necessary to arrange another gas-liquid separator on the hydrogen electrode side, and as an effect, it is possible to downsize the whole of the system. However, in the water electrolysis device in JP 2010-189689 A, oxygen and water are discharged from the discharge communication hole, and therefore, it is necessary to install a large gas-liquid separator downstream of the discharge communication hole.

Hence, in view of the above circumstances, a main object of the present disclosure is to provide a water electrolysis device that makes it possible to downsize the system, and a water electrolysis system that uses the water electrolysis device.

As an aspect for solving the above problem, the present disclosure provides a water electrolysis device including: a water electrolysis stack that includes a cell laminated body in which a plurality of water electrolysis cells is laminated; and a drain pipe that is connected to the water electrolysis stack, wherein: the water electrolysis stack includes a hydrogen electrode side manifold through which hydrogen generated by water electrolysis flows, an oxygen electrode side manifold through which oxygen generated by the water electrolysis flows, and a water supply manifold through which water to be used for the water electrolysis flows; the hydrogen electrode side manifold and the oxygen electrode side manifold pass in a lamination direction; the drain pipe includes a hydrogen electrode side drain pipe that is connected to the hydrogen electrode side manifold, an oxygen electrode side drain pipe that is connected to the oxygen electrode side manifold, and a connection pipe that connects the hydrogen electrode side drain pipe and the oxygen electrode side drain pipe; and the connection pipe includes a drain valve that adjusts the flow rate of water that flows through the connection pipe.

In the above water electrolysis device, the connection pipe may have an inclination. Further, the oxygen electrode side drain pipe may be provided with a water level indicator. Furthermore, the number of the hydrogen electrode side manifolds may be equal to or more than twice the number of the oxygen electrode side manifold.

As an aspect for solving the above problem, the present disclosure provides a water electrolysis system including: the above water electrolysis device; an electric power source that applies voltage to the water electrolysis device; a water supply device that supplies water to the water electrolysis device; a water supply passage that connects the water electrolysis device and the water supply device and through which the water to be supplied from the water supply device to the water electrolysis device flows; a water discharge passage that is connected to the water electrolysis device and through which water to be discharged from the water electrolysis device flows; a hydrogen tank that stores the hydrogen generated by the water electrolysis; a hydrogen flow passage that connects the water electrolysis device and the hydrogen tank and through which hydrogen to be supplied from the water electrolysis device to the hydrogen tank flows; and an oxygen flow passage that is connected to the water electrolysis device and through which the oxygen generated by the water electrolysis flows.

With the water electrolysis device in the present disclosure, the oxygen electrode side manifold and the hydrogen electrode side manifold are through-holes, and have a gas-liquid separation function. Therefore, it is possible to downsize or exclude gas-liquid separators that are disposed on the oxygen electrode side and the hydrogen electrode side. Accordingly, it is possible to downsize the whole of the water electrolysis system.

The water electrolysis system in the present disclosure includes the above water electrolysis device, and therefore it is possible to downsize the whole of the system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a water electrolysis device 100;

FIG. 2 is an exploded perspective view of a water electrolysis cell 10;

FIG. 3 is a schematic view showing a drain pipe 40;

FIG. 4 is an exemplary time chart when water level regulation for the drain pipe is executed using a water level indicator; and

FIG. 5 is a block diagram of the water electrolysis system 1000.

### DETAILED DESCRIPTION OF EMBODIMENTS

### Water Electrolysis Device

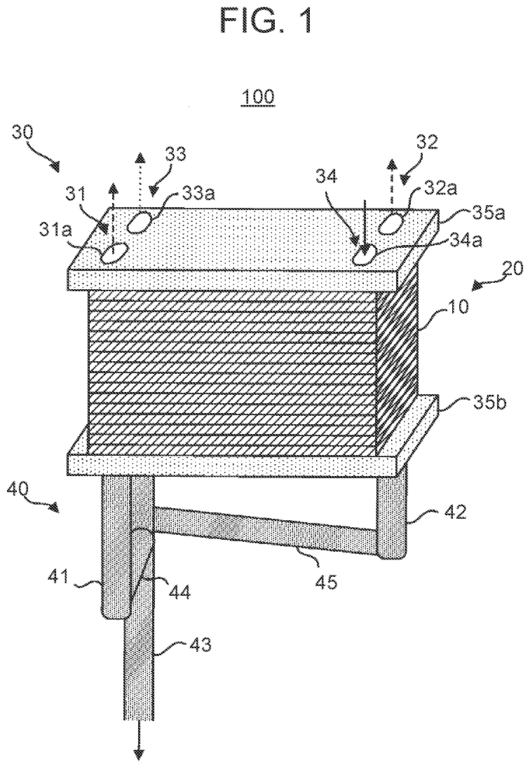

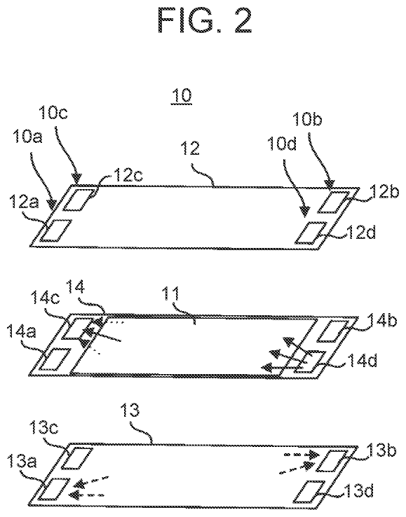

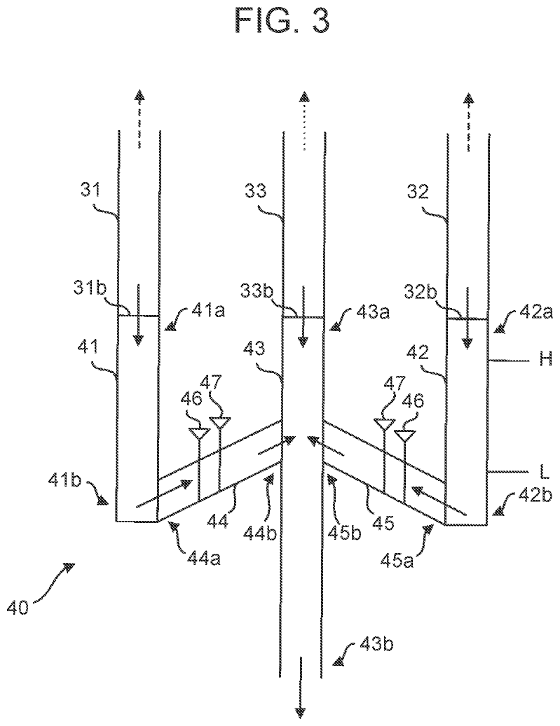

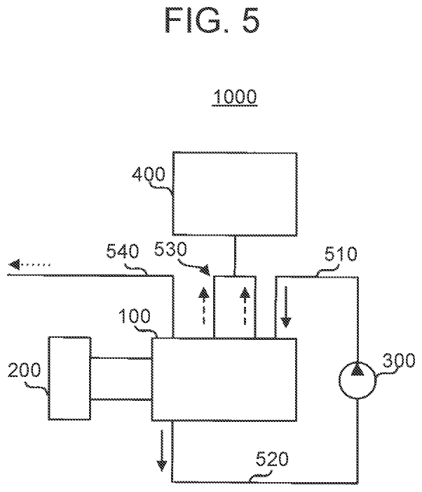

The water electrolysis device in the present disclosure will be described with use of a water electrolysis device 100 in an embodiment. FIG. 1 shows a perspective view of a water electrolysis device 100. In FIG. 1, for convenience, the movement of water is shown by solid line arrows, the movement of oxygen is shown by dotted line arrows, and the movement of hydrogen is shown by broken line arrows. The same goes for FIG. 2, FIG. 3 and FIG. 5.

As shown in FIG. 1, the water electrolysis device 100 includes a water electrolysis stack 30 that includes a cell laminated body 20 in which a plurality of water electrolysis cells 10 is laminated, and a drain pipe 40 that is connected to the water electrolysis stack 30. FIG. 1 shows the water electrolysis device 100 in a state where the lamination direction of the water electrolysis cells 10 coincides with the gravity direction. However, the state of the water electrolysis device 100 is not limited to the state where the 10 lamination direction coincides with the gravity direction, and may be appropriately changed as long as the effect of the water electrolysis device 100 is exerted.

### Water Electrolysis Cell 10

FIG. 2 shows an exploded perspective view of the water electrolysis cell 10. As shown in FIG. 2, the water electrolysis cell 10 includes a membrane electrode assembly 11, and a pair of separators 12, 13 that are disposed on both surfaces of the membrane electrode assembly 11. Further, a frame-shaped member 14 is disposed around the membrane electrode assembly 11.

The membrane electrode assembly 11 includes a solid electrolyte layer, an oxygen electrode catalyst layer that is laminated on one surface of the solid electrolyte layer, and a hydrogen electrode catalyst layer that is laminated on the other surface of the solid electrolyte layer. In the embodiment, the membrane electrode assembly 11 in which the oxygen electrode catalyst layer is laminated on the upper surface of the solid electrolyte layer in the lamination direction and the hydrogen electrode catalyst layer is laminated on the lower surface is used.

The solid electrolyte layer is not particularly limited as long as the solid electrolyte layer has proton conductivity. For example, a polyelectrolyte having a sulfonate group may be adopted. From a standpoint of durability, the polyelectrolyte may be a fluorine-containing polymer. For example, a perfluorocarbon polymer may be adopted.

The oxygen electrode catalyst layer contains an oxygen electrode catalyst that allows oxygen to be generated by water electrolysis. The oxygen electrode catalyst is not particularly limited, and for example, a metal catalyst is adopted. Examples of the metal catalyst may include metal catalysts that contain Pt, Ru, Rh, Os, Ir, Pd, and Au in the composition. Examples of the metal catalyst may include oxides of the metals. The oxygen electrode catalyst may be a carrier that supports a metal catalyst and that has electric conductivity (a metal-supported catalyst). Further, the oxygen electrode catalyst layer may contain an ionomer that has proton conductivity. The ionomer is not particularly limited. For example, a proton-conducting polymer is adopted. Examples of the proton-conducting polymer include a fluoroalkyl polymer such as polytetrafluoroethylene and a fluoroalkyl polymer such as perfluoroalkyl sulfonate polymer.

The hydrogen electrode catalyst layer contains a hydrogen electrode catalyst that allows hydrogen to be generated by water electrolysis. The hydrogen electrode catalyst is not particularly limited, and for example, a metal catalyst is adopted. Examples of the metal catalyst include metal catalysts that contain Pt, Ru, Rh, Os, Ir, Pd, and Au in the composition. Examples of the metal catalyst may include oxides of the metals. The hydrogen electrode catalyst may be a carrier (metal-supported catalyst) that supports a metal catalyst and that has electric conductivity. The kind of the carrier is not particularly limited, and for example, a carbon carrier is adopted. Further, the hydrogen electrode catalyst layer may contain an ionomer that has proton conductivity. The ionomer is not particularly limited. For example, the above-described ionomers are adopted.

The separators 12, 13 are disposed on both surfaces of the membrane electrode assembly 11, respectively. The separator 12 is disposed on the oxygen electrode catalyst layer side. The separator 13 is disposed on the hydrogen electrode catalyst layer side. The separators 12, 13 are formed of a conductive member. For example, a resin material containing a carbon material, a metal material such as iron, copper, stainless steel and titanium, or the like is adopted. Predetermined passages are formed on surfaces on the catalyst layer sides of the separators 12, 13, and the passages play a role in guiding the water to be supplied to the water electrolysis cell 10 and the oxygen and water generated by a water electrolysis reaction.

The frame-shaped member 14 is disposed around the membrane electrode assembly 11. As shown in FIG. 2, the frame-shaped member 14 includes hydrogen electrode holes 14a, 14b, an oxygen electrode hole 14c, and a water supply hole 14d. The material of the frame-shaped member is not particularly limited, and for example, an insulating resin is adopted.

The water electrolysis cell 10 is formed by disposing the pair of separators 12, 13 on both surfaces of the membrane electrode assembly 11 with the frame-shaped member 14. On this occasion, the membrane electrode assembly 11 and the separators 12, 13 are laminated, such that the hydrogen electrode holes 14a, 14b of the frame-shaped member 14 communicates with hydrogen electrode holes 12a, 12b, 13a, 13b of the separators 12, 13, the oxygen electrode hole 14c of the frame-shaped member 14 communicates with oxygen electrode holes 12c, 13c of the separators 12, 13, and the water supply hole 14d of the frame-shaped member 14 communicates with water supply holes 12d, 13d of the separators 12, 13. Hereinafter, these communicating holes are also referred to as hydrogen electrode communication holes 10a, 10b, an oxygen electrode communication hole 10c, and a water supply communication hole 10d.

The water electrolysis reaction in the water electrolysis cell 10 will be described. To the water electrolysis cell 10, water is supplied from the water supply communication hole 10d, and voltage is applied, so that the water electrolysis reaction is developed in each catalyst layer. First, the water is supplied to the oxygen electrode catalyst layer (solid line arrows in FIG. 2), and oxygen and protons are generated by the water electrolysis reaction. The generated oxygen moves along the passage formed on the separator 12, and is taken out to the exterior through the oxygen electrode communication hole 10c (dotted line arrows in FIG. 2). Similarly, the water moves along the passage formed on the separator 12, and is taken out to the exterior through the oxygen electrode communication hole 10c. The protons generated in the oxygen electrode catalyst layer pass through the solid electrolyte layer, and reach the hydrogen electrode catalyst layer. Then, the protons after the reaching are coupled with electrons, so that hydrogen is generated. The generated hydrogen moves along the passage formed on the separator 13, and is taken out to the exterior through the hydrogen electrode communication holes 10a. 10b (broken line arrows in FIG. 2).

### Cell Laminated Body 20

A plurality of water electrolysis cells 10 is laminated, and thereby the cell laminated body 20 is formed. The number of water electrolysis cells 10 that are laminated is not particularly limited, and may be appropriately set depending on an intended performance. In the cell laminated body 20, the plurality of water electrolysis cells 10 is laminated, such that the hydrogen electrode communication holes 10a communicate with each other, the hydrogen electrode communication holes 10b communicate with each other, the oxygen electrode communication holes 10c communicate with each other and the water supply communication holes 10d communicate with each other,

### Water Electrolysis Stack 30

The water electrolysis stack 30 includes the cell laminated body 20. Further, as shown in FIG. 1, end portion plates 35a, 35b are disposed on both end surfaces of the cell laminated body 20, respectively. The end portion plate 35a is disposed on the upper end surface of the cell laminated body 20 in the lamination direction, and the end portion plate 35b is disposed on the lower end surface of the cell laminated body 20 in the lamination direction. Each of the end portion plates 35a, 35b is constituted by a terminal plate, an insulating plate, and an end plate, and the terminal plate, the insulating plate, and the end plate are disposed in this order toward the outside in the lamination direction.

The terminal plates include terminals that are connected to an electric power source in the exterior, and voltage is applied to the terminal plates by the electric power source, so that the voltage is applied to the cell laminated body 20 disposed between the terminal plates. The end plates are members that give binding force to the inside in the lamination direction and that increase the adhesion of the cell laminated body 20. For example, the end plates may bind the cell laminated body 20, using bolts and nuts. The insulating plates play a role in insulation between the terminal plates and the end plates. In the embodiment, the terminal plates, the insulating plates, and the end plates are used as the end portion plates 35a, 35b, and the terminal plates, the insulating plates, and the end plates are not essential. For the end portion plates 35a, 35b, members that are alternative to the terminal plates, the insulating plates, and the end plates may be used.

The water electrolysis stack 30 includes hydrogen electrode side manifolds 31, 32 through which the hydrogen generated by the water electrolysis flows, an oxygen electrode side manifold 33 through which the oxygen generated by the water electrolysis flows, and a water supply manifold 34 through which the water to be used for the water electrolysis flows. As shown by arrows in FIG. 1, in the water electrolysis stack 30, the hydrogen electrode side manifolds 31, 32 and the oxygen electrode side manifold 33 are manifolds on an outlet side, and the water supply manifold 34 is a manifold on an inlet side.

The hydrogen electrode side manifolds 31, 32 are through-holes that pass in the lamination direction, and communicate with the hydrogen electrode communication holes 10a, 10b, respectively. Further, the hydrogen electrode side manifolds 31, 32 communicate also with the end portion plates 35a. 35b. Accordingly, the hydrogen electrode side manifolds 31, 32 each include opening portions on the upper side and lower side in the lamination direction. Opening portions 31a. 32a provided on the upper side in the lamination direction are formed on the end plate of the end portion plate 35a, and opening portions 31b, 32b (FIG. 3) provided on the lower side in the lamination direction are formed on the end plate of the end portion plate 35b.

As described above, the hydrogen generated by the water electrolysis flows through the hydrogen electrode side manifolds 31, 32. However, the water that flows through the oxygen electrode catalyst layer in the water electrolysis cell 10 may pass through the membrane electrode assembly 11, and may leak to the hydrogen electrode catalyst side, in some cases. Therefore, the leaking water may also flow through the hydrogen electrode side manifolds 31, 32, in some cases.

The hydrogen electrode side manifolds 31, 32 that are through-holes have a gas-liquid separation function, and can easily separate the hydrogen and the water. Specifically, the hydrogen having reached the hydrogen electrode side manifolds 31, 32 moves to the upper side in the lamination direction, and is taken out to the exterior through the opening portions 31a, 32a. On the other hand, the water having reached the hydrogen electrode side manifolds 31, 32 move to the lower side in the lamination direction by the influence of gravity force, and is sent to the drain pipe 40 (hydrogen electrode side drain pipes 41, 42) through the opening portions 31b, 32b.

The oxygen electrode side manifold 33 is a through-hole that passes in the lamination direction, and communicates with the oxygen electrode communication hole 10c. Further, the oxygen electrode side manifold 33 communicates also with the end portion plates 35a, 35b. Accordingly, the oxygen electrode side manifold 33 includes opening portions on the upper side and lower side in the lamination direction, respectively. An opening portion 33a provided on the upper side in the lamination direction is formed on the end plate of the end portion plate 35a, and an opening portion 33b (FIG. 3) provided on the lower side in the lamination direction is formed on the end plate of the end portion plate 35b.

In this way, similarly to the hydrogen electrode side manifolds 31, 32, the oxygen electrode side manifold 33 is a through-hole, and therefore has the gas-liquid separation function. As described above, the oxygen and water generated by the water electrolysis flows through the oxygen electrode side manifold 33. Accordingly, the oxygen electrode side manifold 33 can easily separate the oxygen and the water. Specifically, the oxygen having reached the oxygen electrode side manifold 33 moves to the upper side in the lamination direction, and is taken out to the exterior through the opening portion 33a. On the other hand, the water having reached the oxygen electrode side manifold 33 moves to the lower side in the lamination direction by the influence of gravity force, and is sent to the drain pipe 40 (oxygen electrode side drain pipe 43) through the opening portion 33b.

The water supply manifold 34 is a communication hole that communicates with the water supply communication hole 10d. Further, the water supply manifold 34 communicates with the end portion plate 35a. Accordingly, an opening portion 34a provided on the upper side of the water supply manifold 34 in the lamination direction is formed on the end plate of the end portion plate 35a. On the other hand, an end portion on the lower side of the water supply manifold 34 in the lamination direction is closed. Typically, the water supply hole 13d of the separator 13 of the lowest water electrolysis cell 10 in the lamination direction is closed. Further, the closed portion may be provided on the end portion plate 35b. Since the lower end portion of the water supply manifold 34 is closed in this way, the water supplied from the exterior can be supplied to each water electrolysis cell 10.

### Drain Pipe 40

As described above, the hydrogen electrode side manifolds 31, 32 and the oxygen electrode side manifold 33 have the gas-liquid separation function, and move water to the lower side in the lamination direction. The drain pipe 40 has a function to merge and discharge the water. As shown in FIG. 1, the drain pipe 40 includes the hydrogen electrode side drain pipes 41, 42 that are connected to the hydrogen electrode side manifolds 31, 32, the oxygen electrode side drain pipe 43 that is connected to the oxygen electrode side manifold 33, and connection pipes 44, 45 that connect the hydrogen electrode side drain pipes 41, 42 and the oxygen electrode side drain pipe 43. FIG. 3 is a schematic view showing the drain pipe 40.

### Hydrogen Electrode Side Drain Pipe 41, 42

The hydrogen electrode side drain pipes 41, 42 are pipes through which the water separated by the gas-liquid separation function of the hydrogen electrode side manifolds 31, 32 flows. Upper end portions 41a, 42a of the hydrogen electrode side drain pipes 41, 42 in the lamination direction are connected to the opening portions 31b, 32b of the hydrogen electrode side manifolds 31, 32 on the lower side in the lamination direction. Lower end portions 41b, 42b of the hydrogen electrode side drain pipes 41, 42 in the lamination direction are connected to one end portions of the connection pipes 44, 45 (connection positions 44a, 45a). In the water electrolysis device in the present disclosure, the connection positions between the hydrogen electrode side drain pipes and the connection pipes are not limited to the lower end portions of the hydrogen electrode side drain pipes in the lamination direction.

### Oxygen Electrode Side Drain Pipe 43

The oxygen electrode side drain pipe 43 is a pipe through which the water separated by the gas-liquid separation function of the oxygen electrode side manifold 33 flows. An upper end portion 43a of the oxygen electrode side drain pipe 43 in the lamination direction is connected to the opening portion 33b of the oxygen electrode side manifold 33 on the lower side in the lamination direction. The oxygen electrode side drain pipe 43 is connected to the other end portions of the connection pipes 44, 45 (connection positions 44b. 45b). The connection positions 44b, 45b between the oxygen electrode side drain pipe 43 and the connection pipes 44, 45 are not particularly limited. As described later, the connection positions 44b, 45b may be provided on the upper side of the connection positions 44a, 45a in the lamination direction. For example, a lower end portion 43b of the oxygen electrode side drain pipe 43 in the lamination direction may be connected to a drain valve or a circulation pump. In the case where the lower end portion 43b is connected to the circulation pump, the discharged water may be circulated to the water supply manifold 34.

### Connection Pipes 44, 45

The connection pipes 44, 45 are pipes that connect the hydrogen electrode side drain pipes 41, 42 and the oxygen electrode side drain pipe 43 and through which the water separated by the hydrogen electrode side manifolds 31, 32 flows from the hydrogen electrode side drain pipes 41, 42 to the oxygen electrode side drain pipe 43.

In this way, the water separated by the hydrogen electrode side manifolds 31, 32 flows to the oxygen electrode side drain pipe 43 through the hydrogen electrode side drain pipes 41, 42 and the connection pipes 44, 45, and is merged with the water separated by the oxygen electrode side manifold 33. Typically, in the water electrolysis device 100, the pressure of the oxygen electrode side is set so as to be lower than the pressure of the hydrogen electrode side. That is, the pressure of the oxygen generated by the water electrolysis reaction is set so as to be lower than the pressure of the hydrogen. The pressures of the hydrogen and the oxygen can be measured by pressure measurement devices that are installed near outlets (opening portions 31a, 32a, 33a) of the hydrogen electrode side manifolds 31, 32 and the oxygen electrode side manifold 33.

Since the pressure of the oxygen electrode side is set so as to be lower than the pressure of the hydrogen electrode side as described above, there is fear that not only the water but also the hydrogen flows from the hydrogen electrode side drain pipes 41, 42 to the oxygen electrode side drain pipe 43 through the connection pipes 44, 45 due to the difference in pressure. Hence, the water electrolysis device 100 provides drain valves in the connection pipes 44, 45, for preventing the hydrogen from flowing into the oxygen electrode side drain pipe 43.

The drain valve adjusts the flow rate of the water that flows through the connection pipes 44, 45, and includes a shut-off valve 46 and a flow adjustment valve 47 in one embodiment. The shut-off valve 46 is an on-off valve, and operates the flow and shut-off of the water that flows through the connection pipes 44, 45. The flow adjustment valve 47 adjusts the flow rate of the water that flows, and can adjust the flow rate by the opening degree of the valve. The shut-off valve 46 and the flow adjustment valve 47 are disposed from the high-pressure side toward the low-pressure side, that is, from the hydrogen electrode side drain pipes 41, 42 toward the oxygen electrode side drain pipe 43.

A method for preventing the hydrogen from flowing into the oxygen electrode side drain pipe 42 using the shut-off valve 46 and the flow adjustment valve 47 will be described. First, the water is stored in the hydrogen electrode side drain pipes 41, 42, in a state where the shut-off valve 46 and the flow adjustment valve 47 are closed. Next, when the water level reaches a predetermined height, the shut-off valve 46 and the flow adjustment valve 47 are changed to the opening state in this order. At this time, the opening degree of the flow adjustment valve 47 may be appropriately adjusted. Then, when the water level decreases to a predetermined position (which is set to a higher position than the connection positions 44a, 45a for preventing the hydrogen from flowing into the oxygen electrode side drain pipe 42), the shut-off valve 46 and the flow adjustment valve 47 are changed to the closing state. By operating the shut-off valve 46 and the flow adjustment valve 47 in this way, it is possible to prevent the hydrogen from flowing into the oxygen electrode side drain pipe 43.

For easily adjusting the water level of the stored water, water level indicators may be provided in the hydrogen electrode side drain pipes 41, 42. Thereby, it is possible to change the shut-off valve 46 and the flow adjustment valve 47 to the opening state when the water level reaches a predetermined height (H in FIG. 3), and to change the shut-off valve 46 and the flow adjustment valve 47 to the closing state when the water level decreases to a predetermined height (L in FIG. 3).

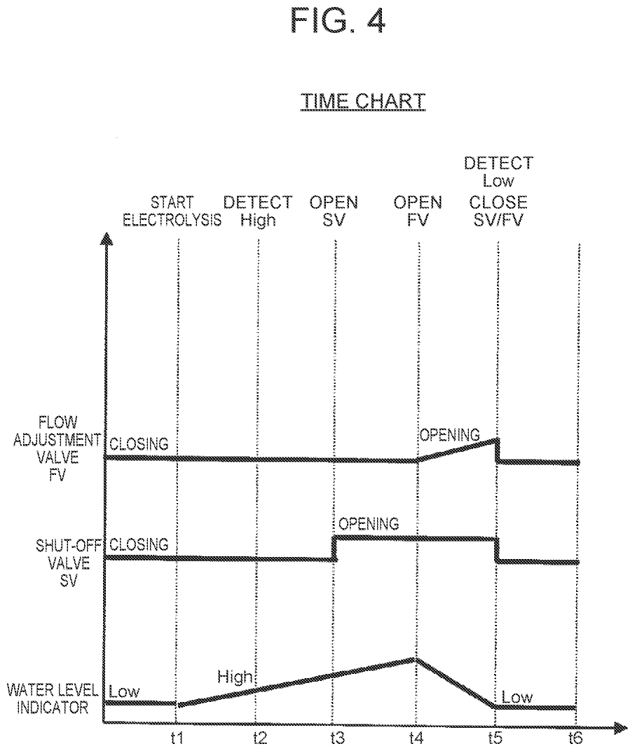

FIG. 4 is an exemplary time chart when water level regulation for the drain pipe is executed using a water level indicator. As shown in FIG. 4, just after the start, the water level indicator indicates low, and the shut-off valve and the flow adjustment valve are in the closing state. Next, at time t1, the water electrolysis starts, and the water level rises as time advances. Then, at time t2, the water level indicator detects that the water level has risen to the predetermined height, and at time t3, the shut-off valve is changed to the opening state. Subsequently, at time t4, the flow adjustment valve is gradually opened, and thereby the water level decreases. Then, at time t5, the water level indicator detects that the water level has decreased to the predetermined height, and the shut-off valve and the flow adjustment valve are changed to the closing state. The water level does not change, and therefore, at time t6, the shut-off valve and the flow adjustment valve are maintained in the closing state.

Furthermore, the connection pipes 44, 45 will be described. As shown in FIG. 1 and FIG. 3, the connection pipes 44, 45 have inclinations. The inclinations are set so as to become higher from the high-pressure side toward the low-pressure side, that is, from the hydrogen electrode side drain pipes 41, 42 toward the oxygen electrode side drain pipe 43. This means that the connection positions 44b, 45b between the oxygen electrode side drain pipe 43 and the connection pipes 44, 45 exist on the lamination-directional upper side of the connection positions 44a, 45a between the hydrogen electrode side drain pipes 41, 42 and the connection pipes 44, 45. Since the connection pipes 44, 45 have the inclinations in this way, it is possible to further prevent the hydrogen from flowing into the oxygen electrode side drain pipe 43. The inclinations may be provided at parts of the connection pipes 44, 45, or may be provided over the wholes from a standpoint of the increase in effect. Further, the inclination angle is not particularly limited, and may be appropriately set depending on the purpose.

### Effect

Conventionally, in the water electrolysis system, the hydrogen and water discharged from the hydrogen electrode side manifold are separated by a gas-liquid separator. Further, the oxygen and water discharged from the oxygen electrode side manifold are separated by a gas-liquid separator. In this way, in the conventional water electrolysis system, the gas-liquid separators are provided on both of the oxygen electrode side and the hydrogen electrode side. On the other hand, the water electrolysis device 100 includes the hydrogen electrode side manifolds 31, 32 and the oxygen electrode side manifold 33 that have the gas-liquid separation function, as described above. Therefore, it is possible to downsize or exclude the gas-liquid separators that are provided on the oxygen electrode side and the hydrogen electrode side in the water electrolysis system. Accordingly, with the water electrolysis device 100, it is possible to downsize the whole of the water electrolysis system.

In the water electrolysis device 100, the water separated by the hydrogen electrode side manifold 31, 32 and the water separated by the oxygen electrode side manifold 33 flow into the hydrogen electrode side drain pipes 41, 42 and the oxygen electrode side drain pipe 43, respectively. The water having flowed into the hydrogen electrode side drain pipes 41, 42 flows into the oxygen electrode side drain pipe 43 through the connection pipes 44, 45. Thereby, it is possible to collect the water to be drained, in the oxygen electrode side drain pipe 43, and therefore it is possible to enhance drainage efficiency.

However, as described above, in the water electrolysis device 100, typically, the pressure of the oxygen electrode side is set so as to be lower than the pressure of the hydrogen electrode side. Therefore, there is fear that the hydrogen flows from the hydrogen electrode side drain pipes 41, 42 into the oxygen electrode side drain pipe 43 through the connection pipes 44, 45 due to the difference in pressure. Hence, in the water electrolysis device 100, for preventing the reverse flow of gas due to the difference in pressure, the drain valves (the shut-off valves 46 and the flow adjustment valves 47) are provided in the connection pipes 44, 45. Thereby, it is possible to prevent the reverse flow of gas in the drain pipe 40.

### Supplement

In the water electrolysis device 100, the number of hydrogen electrode side manifolds is twice the number of oxygen electrode side manifolds. This is because the amount of the hydrogen that is generated by the water electrolysis reaction is twice the amount of the oxygen that is generated by the water electrolysis reaction. Accordingly, since the water electrolysis device 100 includes hydrogen electrode side manifolds such that the number of hydrogen electrode side manifolds is twice the number of oxygen electrode side manifolds, it is possible to reduce the pressure drop due to the hydrogen generated by the water electrolysis reaction. In the water electrolysis device in the present disclosure, the number of hydrogen electrode side manifolds may be less than twice the number of oxygen electrode side manifolds. For example, the number of hydrogen electrode side manifolds may be the same as the number of oxygen electrode side manifolds. However, from a standpoint of the reduction in pressure drop, the number of hydrogen electrode side manifold may be equal to or more than twice of the number of oxygen electrode side manifolds.

In the water electrolysis device 100, the structure of the drain pipe 40 is decided based on such a setting that the pressure of the oxygen electrode side is lower than the pressure of the hydrogen electrode side. However, in the water electrolysis device in the present disclosure, the pressure of the hydrogen electrode side may be set so as to be lower than the pressure of the oxygen electrode side. In this case, the water separated by the water electrolysis stack may be collected in the hydrogen electrode side drain pipes on the low-pressure side, and may be discharged to the exterior. Further, the inclinations of the connection pipes may be set such that heights of the connection pipes become higher from the oxygen electrode side drain pipe toward the hydrogen electrode side drain pipes.

### Water Electrolysis System

By using the above water electrolysis device, it is possible to downsize the whole of the water electrolysis system. In the present disclosure, the water electrolysis system that uses the above water electrolysis device will be described with use of an embodiment. The embodiment is a mode in which the gas-liquid separator is not included on the oxygen electrode side and the hydrogen electrode side. However, in the water electrolysis system in the present disclosure, the gas-liquid separator may be provided on at least one of the oxygen electrode side and the hydrogen electrode side.

The embodiment is a water electrolysis system 1000 including: the above water electrolysis device 100; an electric power source 200 that applies voltage to the water electrolysis device 100; a water supply device 300 that supplies water to the water electrolysis device 100; a water supply passage 510 that connects the water electrolysis device 100 and the water supply device 300 and through which the water to be supplied from the water supply device 300 to the water electrolysis device 100 flows; a water discharge passage 520 that is connected to the water electrolysis device 100 and through which the water to be discharged from the water electrolysis device 100 flows; a hydrogen tank 400 that stores the hydrogen generated by the water electrolysis; a hydrogen flow passage 530 that connects the water electrolysis device 100 and the hydrogen tank 400 and through which the hydrogen to be supplied from the water electrolysis device 100 to the hydrogen tank 400 flows; and an oxygen flow passage 540 that is connected to the water electrolysis device 100 and through which the oxygen generated by the water electrolysis reaction flows. FIG. 5 shows a block diagram of the water electrolysis system 1000.

The water electrolysis device 100 has been described above, and therefore the description is omitted. The electric power source 200 applies voltage to the water electrolysis device 100, and develops the water electrolysis reaction in the water electrolysis device 100. Such an electric power source 200 is publicly known. The electric power source 200 is connected to each of the terminal plates of the end portion plates 35a, 35b of the water electrolysis device 100. The water supply device 300 supplies water to the water electrolysis device 100. Such a water supply device 300 is publicly known. The hydrogen tank 400 stores the hydrogen generated by the water electrolysis. Such a hydrogen tank 400 is publicly known.

The water supply passage 510 is a pipe through which the water to be supplied from the water supply device 300 to the water electrolysis device 100 flows. The water supply passage 510 is connected to the opening portion 34a of the water supply manifold 34 of the water electrolysis device 100.

The water discharge passage 520 is a pipe that is connected to the water electrolysis device 100 and through which the water to be discharged from the water electrolysis device 100 flows. The water discharge passage 520 is connected to the oxygen electrode side drain pipe 43 of the water electrolysis device 100. The water to be discharged from the water electrolysis device 100 may be discharged to the exterior through the water discharge passage 520, but may be sent to the water supply device 300 as shown in FIG. 5. That is, the water discharge passage 520 may connect the oxygen electrode side drain pipe 43 and the water supply device 300. Thereby, the water can be reused.

The hydrogen flow passage 530 is a pipe that connects the water electrolysis device 100 and the hydrogen tank 400 and through which the hydrogen to be supplied from the water electrolysis device 100 to the hydrogen tank 400 flows. The hydrogen flow passage 530 is connected to each of the opening portions 31a, 32a of the hydrogen electrode side manifolds 31, 32 of the water electrolysis device 100. As shown in FIG. 5, the hydrogen flow passage 530 may merge the hydrogen flowing from the hydrogen electrode side manifold 31 and the hydrogen flowing from the hydrogen electrode side manifold 32.

The oxygen flow passage 540 is a pipe that is connected to the water electrolysis device 100 and through which the oxygen generated by the water electrolysis reaction flows. The oxygen flow passage 540 is connected to the opening portion 33a of the oxygen electrode side manifold 33 of the water electrolysis device 100. The oxygen to be discharged from the water electrolysis device 100 may be discharged to the exterior through the oxygen flow passage 540.

What is claimed is:

1. A water electrolysis device comprising:
a water electrolysis stack that includes a cell laminated body in which a plurality of water electrolysis cells is laminated; and
a drain pipe that is connected to the water electrolysis stack, wherein:
the water electrolysis stack includes
a hydrogen electrode side manifold through which hydrogen generated by water electrolysis flows,
an oxygen electrode side manifold through which oxygen generated by the water electrolysis flows, and
a water supply manifold through which water to be used for the water electrolysis flows;
the hydrogen electrode side manifold and the oxygen electrode side manifold pass in a lamination direction;
the drain pipe includes
a hydrogen electrode side drain pipe that is connected to the hydrogen electrode side manifold,
an oxygen electrode side drain pipe that is connected to the oxygen electrode side manifold, and
a connection pipe that connects the hydrogen electrode side drain pipe and the oxygen electrode side drain pipe; and
the connection pipe includes a drain valve that adjusts a flow rate of water that flows through the connection pipe.

2. The water electrolysis device according to claim 1, wherein the connection pipe has an inclination.

3. The water electrolysis device according to claim 1, wherein the oxygen electrode side drain pipe is provided with a water level indicator.

4. The water electrolysis device according to claim 1, wherein the number of the hydrogen electrode side manifolds is equal to or more than twice the number of the oxygen electrode side manifold.

5. A water electrolysis system comprising:
the water electrolysis device according to claim 1;
an electric power source that applies voltage to the water electrolysis device;
a water supply device that supplies water to the water electrolysis device;
a water supply passage that connects the water electrolysis device and the water supply device and through which the water to be supplied from the water supply device to the water electrolysis device flows;
a water discharge passage that is connected to the water electrolysis device and through which water to be discharged from the water electrolysis device flows;
a hydrogen tank that stores the hydrogen generated by the water electrolysis;
a hydrogen flow passage that connects the water electrolysis device and the hydrogen tank and through which hydrogen to be supplied from the water electrolysis device to the hydrogen tank flows; and
an oxygen flow passage that is connected to the water electrolysis device and through which the oxygen generated by the water electrolysis flows.
